(19) United States
(12) Patent Application Publication
(10) Pub. No.: US 2024/0164252 A1
(43) Pub. Date: May 23, 2024

(54) STRAW AND CHAFF SPREADER FOR COMBINE HARVESTER

(71) Applicant: 102159303 Saskatchewan Ltd., Vanguard (CA)

(72) Inventor: Wesley Kirby, Vanguard (CA)

(21) Appl. No.: 17/990,307

(22) Filed: Nov. 18, 2022

(51) Int. Cl. A01D 41/12

(52) U.S. Cl. CPC A01D 41/1243

(57) ABSTRACT

A straw and chaff spreader for use with a combine harvester, having two side-by-side housings, each housing having an egress, with a centrally axially disposed rotatable member in each housing and extending above the housing. Each rotatable member rotates upper flails above the housing to engage and spread some of the straw and chaff, remaining straw and chaff falling along a contoured surface of the rotatable member into the housing, and also rotates lower arms within the housings to generate air flow to eject the remaining straw and chaff through the egress. The flails overlap and so are disposed at different heights to avoid interference during rotation.

### TECHNICAL HELD OF THE INVENTION

The present invention relates to material spreading apparatus, and more particularly to apparatus for spreading straw and chaff generated by a combine harvester.

### BACKGROUND OF THE INVENTION

It is known in the art of crop harvesting that the use of threshing technologies generates waste materials such as straw and chaff. In the case of combine harvesters and the like, straw and chaff are separated from the target grain by threshing and then expelled rearwardly as the combine harvester progresses through the field being harvested. Such waste material has commonly been windrowed for gathering and storage or bundling in bales. It has also been known to instead spread the waste materials across the ground as the combine harvester progresses through the field, either for turning it into the soil by cultivation or simply to leave it evenly spread on the ground surface.

Various prior art systems have been disclosed for spreading waste materials such as straw and chaff on the ground. For example, Canadian Patent No. 1,179,567 to Clarke teaches a chaff spreader comprising a pair of fans within a housing positioned beneath a cleaning shoe, the fans configured to eject chaff from the housing through sideways-directed discharge nozzles and thus prevent rearward discharge. However, Clarke expressly is not directed to straw spreading. In another example, Canadian Patent No, 2,066,860 to Kirby teaches an apparatus for spreading both straw and chaff, wherein a rotating flail ejects straw outwardly while chaff moving downwardly past the flail into a housing is ejected through sideways-directed apertures in the housing. Canadian Patent Application No. 2,150,754 to Cruson teaches a straw chopping mechanism, expressly intended for use with devices like Kirby.

A need remains for straw and chaff spreaders that have improved waste material capture and enhanced spread.

### SUMMARY OF THE INVENTION

According to a first broad aspect of the present invention, there is provided a straw and chaff spreader comprising:
two generally circular housings in side-by-side arrangement;
each of the housings having a floor and a peripheral wall, each peripheral wall having an egress;
each of the housings provided with a centrally disposed rotatable member axially aligned with the housing, each rotatable member extending upwardly from the floor; each rotatable member having a surface shape extending generally downwardly and outwardly;
a flail mounted adjacent an upper end of each of the rotatable members for rotation therewith, the flail configured to contact and spread a portion of the straw and chaff beyond the spreader, a remaining portion of the straw and chaff passing therethrough into each of the housings;
the flails overlapping when rotated, and one of the flails positioned higher than another of the flails to avoid interference therebetween; and
arms mounted adjacent the floor on the rotatable members for rotation therewith and extending outwardly toward the peripheral wall, for causing air flow toward the peripheral wall and the egress when rotated, such that the remaining portion of the straw and chaff are ejected through the egress after passing downwardly and outwardly along the surface shape of the rotatable members.

In some exemplary embodiments of the first broad aspect, the straw and chaff is directed toward the flails from a combine harvester. The housings preferably open upwardly for receipt of the remaining portion of the straw and chaff.

In some embodiments the peripheral wall is provided with a deflector along a portion thereof for retaining the remaining portion of the straw and chaff within the housing until ejected through the egress.

Exemplary embodiments further comprise a power source for rotating the rotatable members.

The surface shape of the rotatable members is preferably but not necessarily frustoconical.

The flails are preferably flexible and composed of rubber. In some embodiments each flail is a plurality of outwardly extending flail members. The arms preferably comprise outwardly-disposed fan members for causing the air flow.

According to a second broad aspect of the present invention, there is provided an apparatus for spreading straw and chaff generated by a combine harvester, the apparatus configured for mounting adjacent a straw and chaff exit chute of the combine harvester for receiving the straw and chaff therefrom, the apparatus comprising:
first and second circular housings in side-by-side horizontal arrangement, each of the housings comprising:
a floor; and
a peripheral wall extending generally upwardly from the floor, the peripheral wall comprising an egress;
first and second rotatable members rotatably mounted at a proximal end thereof centrally and coaxially in the first and second housings, respectively, each of the first and second rotatable members provided with a generally frustoconical surface extending downwardly and outwardly at the proximal end thereof;
a power source for driving axial rotation of the first and second rotatable members;
first and second flails mounted adjacent distal ends of the first and second rotatable members, respectively, for rotation with the first and second rotatable members, the first and second flails above the peripheral wall and overlapping when rotated, and the first flail positioned higher than the second flail to avoid interference between the first and second flails when rotated; and
first and second generally horizontal arms mounted adjacent the proximal ends of the first and second rotatable members, respectively, for rotation with the first and second rotatable members, the first and second generally horizontal arms extending outwardly toward the peripheral wall and when rotated cause air flow toward the peripheral wall and the egress;
wherein when the straw and chaff are ejected from the straw and chaff exit chute they engage the first and second flails the rotation of which causes outward spreading of some of the straw and chaff, remaining straw and chaff passing downwardly into the first and second circular housings;
wherein the remaining straw and chaff pass downwardly and outwardly along the generally frustoconical shape of the first and second rotatable members toward the first and second generally horizontal arms; and
wherein the air flow caused by the rotation of the generally horizontal arras ejects the remaining straw and chaff through the egress.

In some exemplary embodiments of the second broad aspect, the first and second housings open upwardly for receipt of the remaining straw and chaff. An upper portion of the peripheral wall may optionally comprises a deflector for containing the remaining straw and chaff until ejection through the egress.

The flails are preferably composed of a flexible rubber. Each flail may be a plurality of flail members extending outwardly from the rotatable members. The generally horizontal arms may further comprise outwardly mounted paddle members for causing the air flow.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is a rear perspective view of an exemplary embodiment according to the present invention.

FIG. 2 is a top plan view of an exemplary embodiment according to the present invention.

FIG. 3 is a partly cut-away elevation view of a second housing of an exemplary embodiment according to the present invention.

FIG. 4 is a rear elevation view of a spreader according to an exemplary embodiment of the present invention applied to a combine harvester.

FIG. 5 is a rear perspective view of the spreader of FIG. 4 applied to a combine harvester.

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to a spreader for waste material such as straw and chaff that are for example generated by a thresher like a combine harvester. The spreader combines straw-throwing flails and an air flow side-ejection area driven by rotating arms primarily for spreading smaller waste like chaff. There are two flail arrangements side-by-side that overlap in operation, and one of the flail arrangements is positioned higher than the other to reduce the risk of interference between the two flail arrangements. Further, the spreader comprises rotating members to drive both the flail arrangements and the arms, and the rotating member are provided with contoured surfaces to help direct the smaller waste outwardly for ease of ejection.

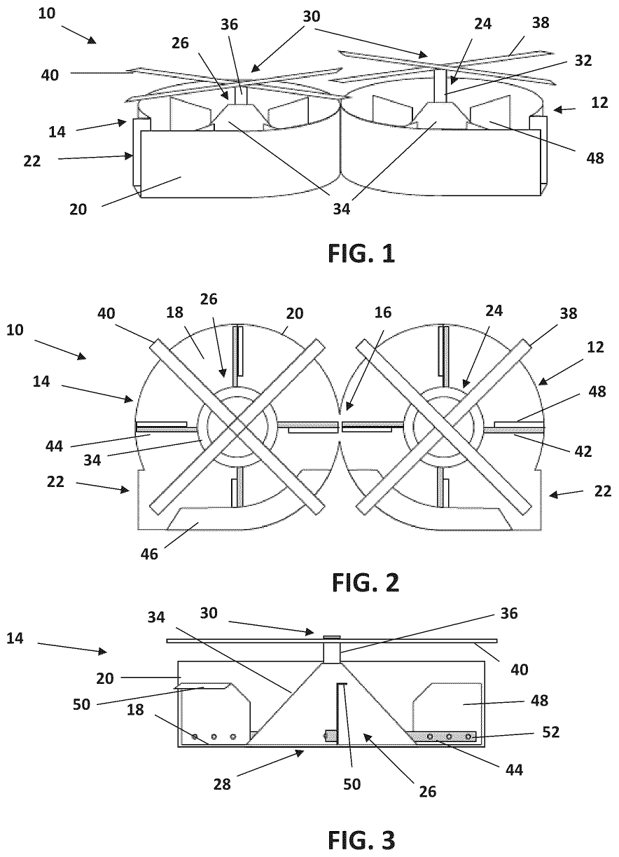

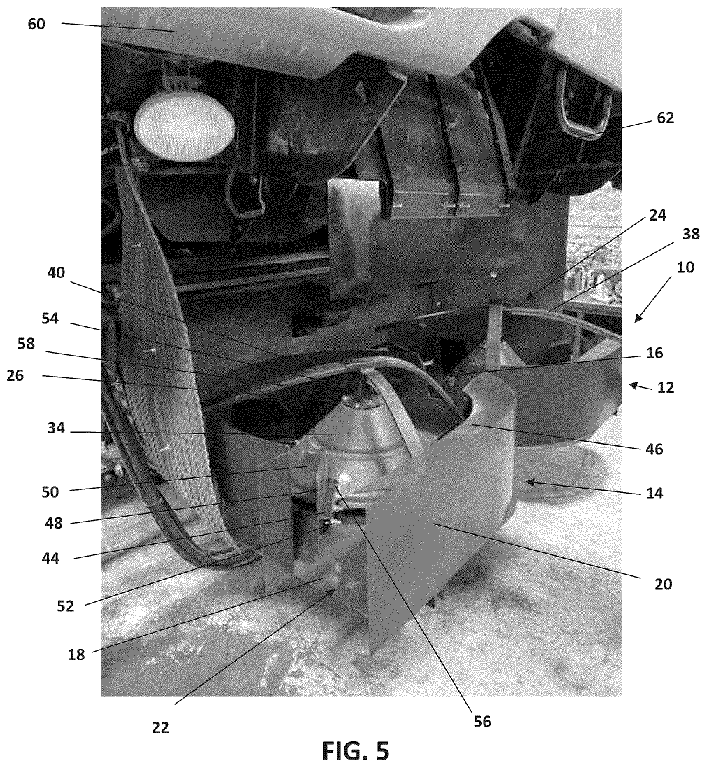

Turning now to the Figures, exemplary embodiments of the present invention are illustrated. FIG. 1 illustrates a straw and chaff spreader 10. The exemplary spreader 10 comprises first and second generally circular housings 12, 14 which are supported in a side-by-side horizontal arrangement, and may have an aperture 16 between them (as shown in FIGS. 2 and 5). Each of the housings 12, 14 comprises a floor 18, with a peripheral wall 20 extending generally upwardly from the floor 18 to form a partly enclosed space opening upwardly. Each of the peripheral walls 20 are provided with an egress 22 or opening through which crop waste is intended to be expelled in operation of the spreader 10.

The first and second housings 12, 14 contain first and second rotatable members 24, 26, respectively, which extend vertically upwards and are rotatably mounted centrally and coaxially in and with the first and second housings 12, 14. Each of the rotatable members 24, 26 have a proximal end 28 and a distal end 30. In the illustrated embodiment, each of the first and second rotatable members 24, 26 are provided with a generally frustoconical surface 34 extending downwardly and outwardly at the proximal end 28, but any shape tending to direct straw and chaff outwardly toward the peripheral wall 20 as they fall may be of use with embodiments of the present invention.

The distal ends 30 of the rotatable members 24, 26 are provided with flails or straps configured to rotate (driven by the rotatable members 24, 26 as they themselves rotate) and thereby contact straw as it falls downwardly towards the spreader 10. In the illustrated embodiment there are first flails 38 mounted on the distal end 30 of the first rotatable member 24 and second flails 40 mounted on the distal end 30 of the second rotatable member 26. In the illustrated embodiment, the first and second flails 38, 40 each comprise two flail portions overlapping in the middle to form an X shape in plan, with each secured centrally. When rotated, the outward ends of the first and second flails 38, 40 lift toward horizontal into a plane of rotation disposed above the peripheral wall 20 of the housings 12, 14. Of particular importance, the first flails 38 are positioned at a height greater than the second flails 40 relative to the floor 18 of the housings 12, 14; in this way, the flails 38, 40 can overlap and still rotate without interference contact with each other, thereby enhancing contact with and spreading of the straw passing into the plane of rotation. In the illustrated embodiment, this height difference is achieved by having a shaft 32 of the first rotatable member 24 longer than a shaft 36 of the second rotatable member 26. In one exemplary embodiment, the portion of the shaft 32 extending above the frustoconical surface 34 is 5 inches high, whereas the portion of the shaft 36 extending above the frustoconical surface 34 is only 2 inches high.

While the rotating flails 38, 40 serve to throw at least some of the straw outwardly away from the combine harvester, smaller pieces of straw and chaff may fall through the planes of rotation, where they descend into the housings 12, 14. Turning now to FIGS. 1 to 3, the spreader 10 further comprises means for ejecting smaller waste such as chaff from the spreader 10. As described above, the rotatable members 24, 26 are provided with a contoured surface such as the frustoconical surface 34, which aids in directing straw and chaff outwardly toward the peripheral wall 20 and ultimately the egress 22. To forcefully eject the straw and chaff outwardly through the egress 22 in each of the housings 12, 14, the spreader 10 further comprises first and second generally horizontal arms 42, 44. The first arms 42 are mounted on the first rotatable member 24 at the proximal end 28 thereof for counter-clockwise rotation, whereas the second arms 44 are mounted on the second rotatable member 26 at the proximal end 28 thereof for clockwise rotation, when the rotatable members 24, 26 are rotated. As can be seen in FIG. 2, the planes of rotation of the arms 42, 44 do not touch but come very close, reducing the amount of waste that might otherwise accumulate between them. As the arms 42, 44 rotate along and slightly above the floor 18 of the housings 12, 14, they generate air flow to help eject the waste from the housings 12, 14, the counter-clockwise rotation of the first arms 42 and the clockwise rotation of the second arms 44 driving the straw and chaff toward the egress 22 in each housing 12, 14. The egress 22 in each of the peripheral walls 20 is directed sideways to eject waste away from the path of travel and to more evenly spread the waste on the ground surface.

Each of the illustrated arms 42, 44 are provided with paddle members 48 at outward ends thereof, to aid in generating the air flow necessary to forcefully eject the waste from the spreader 10. The paddle members 48 are affixed to the arms 42, 44 by means of bolts 52 in the illustrated embodiment. The paddle members 48 may be provided with upper deflectors 50 as shown in FIGS. 2 and 3, to help direct the smaller waste toward the egress 22. To the same end, the peripheral wall 20 may be provided with an upper deflector 46, as shown in FIGS. 2 and 5 to help retain the smaller waste within the housings 12, 14 until ejection through the egress 22.

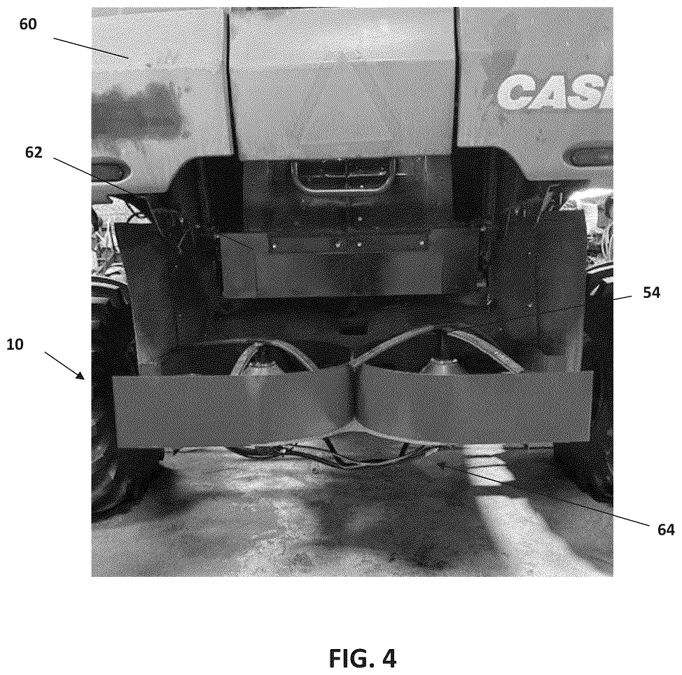

Turning to FIGS. 4 and 5, an exemplary embodiment is shown wherein the spreader 10 is mounted on a combine harvester 60. The combine harvester 60 comprises a straw and chaff exit chute 62 which feeds straw and chaff toward the spreader 10. Power lines 64 are shown in FIG. 4, whereby power is provided to the rotatable members 24, 26 to enable their axial rotation (and through them, rotation of the flails 38, 40 and arms 42, 44); the power system may be any known system suitable for use with the combine harvester 60, such as for one non-limiting example a hydraulic power system. The power source 64 would be connected in a conventional manner to the shafts 32, 36 to impart axial rotation thereof.

FIG. 5 shows an exemplary flail connector 54, which is secured to the shafts 32, 36 and connects the flails 38, 40 to the distal ends 30 of the rotatable members 24, 26. The flail connector 54 is further secured to an upper end of the frustoconical surface 34 by means of bolts 58. FIG. 5 further shows how the arms 42, 44 pass through holes 56 in the frustoconical surface 34 to engage the rotatable members 24, 26 for rotation therewith.

The foregoing is considered as illustrative only of the principles of the present invention. The scope of the claims should not be limited by the exemplary embodiments set forth in the foregoing, but should be given the broadest interpretation consistent with the specification as a whole.

1. A straw and chaff spreader comprising:
two generally circular housings in side-by-side arrangement;
each of the housings having a floor and a peripheral wall, each peripheral wall having an egress;
each of the housings provided with a centrally disposed rotatable member axially aligned with the housing, each rotatable member extending upwardly from the floor;
each rotatable member having a surface shape extending generally downwardly and outwardly;
a flail mounted adjacent an upper end of each of the rotatable members for rotation therewith, the flail configured to contact and spread a portion of the straw and chaff beyond the spreader, a remaining portion of the straw and chaff passing therethrough into each of the housings;
the flails overlapping when rotated, and one of the flails positioned higher than another of the flails to avoid interference therebetween; and
arms mounted adjacent the floor on the rotatable members for rotation therewith and extending outwardly toward the peripheral wall, for causing air flow toward the peripheral wall and the egress when rotated, such that the remaining portion of the straw and chaff are ejected through the egress after passing downwardly and outwardly along the surface shape of the rotatable members.

2. The spreader of claim 1 wherein the straw and chaff is directed toward the flails from a combine harvester.

3. The spreader of claim 1 wherein the housings open upwardly for receipt of the remaining portion of the straw and chaff.

4. The spreader of claim 1 wherein the peripheral wall is provided with a deflector along a portion thereof for retaining the remaining portion of the straw and chaff within the housing until ejected through the egress.

5. The spreader of claim 1 further comprising a power source for rotating the rotatable members.

6. The spreader of claim 1 wherein the surface shape of the rotatable members is frustoconical.

7. The spreader of claim 1 wherein the flails are flexible and composed of rubber.

8. The spreader of claim 1 wherein each flail is a plurality of outwardly extending flail members.

9. The spreader of claim 1 wherein the arms comprise outwardly-disposed fan members for causing the air flow.

10. An apparatus for spreading straw and chaff generated by a combine harvester, the apparatus configured for mounting adjacent a straw and chaff exit chute of the combine harvester for receiving the straw and chaff therefrom, the apparatus comprising:
first and second circular housings in side-by-side horizontal arrangement, each of the housings comprising:
a floor; and
a peripheral wall extending generally upwardly from the floor, the peripheral wall comprising an egress;
first and second rotatable members rotatably mounted at a proximal end thereof centrally and coaxially in the first and second housings, respectively, each of the first and second rotatable members provided with a generally frustoconical surface extending downwardly and outwardly at the proximal end thereof;
a power source for driving axial rotation of the first and second rotatable members;
first and second flails mounted adjacent distal ends of the first and second rotatable members, respectively, for rotation with the first and second rotatable members, the first and second flails above the peripheral wall and overlapping when rotated, and the first flail positioned higher than the second flail to avoid interference between the first and second flails when rotated; and
first and second generally horizontal arms mounted adjacent the proximal ends of the first and second rotatable members, respectively, for rotation with the first and second rotatable members, the first and second generally horizontal arms extending outwardly toward the peripheral wall and when rotated cause air flow toward the peripheral wall and the egress;
wherein when the straw and chaff are ejected from the straw and chaff exit chute they engage the first and second flails the rotation of which causes outward spreading of some of the straw and chaff, remaining straw and chaff passing downwardly into the first and second circular housings;
wherein the remaining straw and chaff pass downwardly and outwardly along the generally frustoconical shape of the first and second rotatable members toward the first and second generally horizontal arms; and
wherein the air flow caused by the rotation of the generally horizontal arms ejects the remaining straw and chaff through the egress.

11. The apparatus of claim 10 wherein the first and second housings open upwardly for receipt of the remaining straw and chaff.

12. The apparatus of claim 10 wherein an upper portion of the peripheral wall comprises a deflector for containing the remaining straw and chaff until ejection through the egress.

13. The apparatus of claim 10 wherein the flails are composed of a flexible rubber.

14. The apparatus of claim 10 wherein each flail is a plurality of flail members extending outwardly from the rotatable members.

15. The apparatus of claim 10 wherein the generally horizontal arms comprise outwardly mounted paddle members for causing the air flow.
